(19) United States
(12) Patent Application Publication
(10) Pub. No.: US 2007/0275649 A1
(43) Pub. Date: Nov. 29, 2007

(54) Pop-up vent

(75) Inventors: James Hill, Grosse Pointe Park, MI (US); Olivier Boinais, West Bloomfield, MI (US)

Correspondence Address: KAPLAN GILMAN GIBSON & DERNIER L.L.P., 900 ROUTE 9 NORTH, WOODBRIDGE, NJ, 07095, US

(73) Assignee: Faurecia Interior Systems U.S.A., Inc., Auburn Hills, MI (US)

(21) Appl. No.: 11/406,697

(22) Filed: Apr. 19, 2006

(51) Int. Cl. B60H 1/00

(52) U.S. Cl. 454/69

(57) ABSTRACT

An air vent for a vehicle is disclosed which may include a sleeve coupled to a recessed flange which terminates at a surface of an instrument panel; a tube disposed within the sleeve, being operable to move substantially linearly within the sleeve, and including an air outlet; and a spring assembly operable to bias the tube toward an interior of the vehicle.

### BACKGROUND OF THE INVENTION

The present invention relates in general to ventilation and in particular to ventilation directed to heating and/or cooling the interior space of a vehicle.

Air vents are commonly deployed in vehicles to provide air flow to either heat, cool, or merely circulate fresh air through the interior space, or passenger compartment, of a vehicle. In most such air vents, air flow through the air outlets is controlled by manipulating the positions of a plurality of louvers within the air vent housing and/or by manipulating the air vent housing itself. However, the range of adjustment of the air flow direction is quite limited in such existing systems.

Moreover, the air outlets are generally permanently exposed to and viewable from the passenger compartment. Air outlets may possess undesirable aesthetic characteristics, such as by presenting a visual non-uniformity with surrounding portions of an instrument panel. And, existing air vents generally do not provide means for covering the air outlets.

One existing system provides a pivoting air outlet housing, in which the air outlets are exposed to the passenger compartment when the air vent is open and are concealed from view when the air outlet is closed. While this approach provides better aesthetic characteristics than air vents having permanently exposed air outlets, a portion of the air outlet housing is still immediately adjacent to portions of the instrument panel surface even when the air vent is closed. Moreover, air flow direction control within a horizontal plane of the passenger compartment is implemented by manipulating the orientation of a plurality of louvers and is thus limited to a narrow range of angular motion.

Accordingly, there is a need in the art for an air vent that enables improved concealment of the air outlet when the air vent is closed, while enabling an improved range of air flow direction control when the air vent is open.

### SUMMARY OF THE INVENTION

According to one aspect, the invention may provide an air vent for a vehicle that may include a sleeve coupled to a recessed flange which terminates at a surface of an instrument panel; a tube disposed within the sleeve, being operable to move substantially linearly within the sleeve, and including an air outlet; and a spring assembly operable to bias the tube toward an interior of the vehicle.

Preferably, when the air vent is closed, an end cap of the tube is retracted further from an interior of the vehicle than the instrument panel surface and the air outlet is retracted within the sleeve, thereby blocking air flow through the air outlet. Preferably, when the air vent is open, the tube is located within the sleeve such that the air outlet is extended beyond a junction of the sleeve and the recessed flange, thereby enabling air flow through the air outlet. Preferably, the tube is rotatable within the sleeve. Preferably, the tube is rotatable to any angular position about a longitudinal axis thereof.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is an elevational view of an instrument panel including a plurality of air vents located inside a vehicle in accordance with one or more embodiments of the present invention;

FIG. 2 is a perspective view of the instrument panel of FIG. 1 in accordance with one or more embodiments of the present invention;

FIG. 3 is a perspective view of an open air vent in accordance with one or more embodiments of the present invention;

FIG. 4 is a perspective view of the air vent of FIG. 3 in a closed position, in accordance with one or more embodiments of the present invention;

FIG. 5 is a partially elevational and partially sectional view of the air vent of FIGS. 3-4 in accordance with one or more embodiments of the present invention;

FIG. 6 is a partially elevational and partially sectional view of a push-push latch mechanism adaptable for use as a spring assembly in one or more embodiments of the air vent assembly of FIGS. 3-5; and

FIG. 7 is a partially elevational view and partially sectional view of the push-push latch mechanism of FIG. 6 in accordance with one or more embodiments of the present invention.

### DETAILED DESCRIPTION OF THE PREFERRED EMBODIMENTS

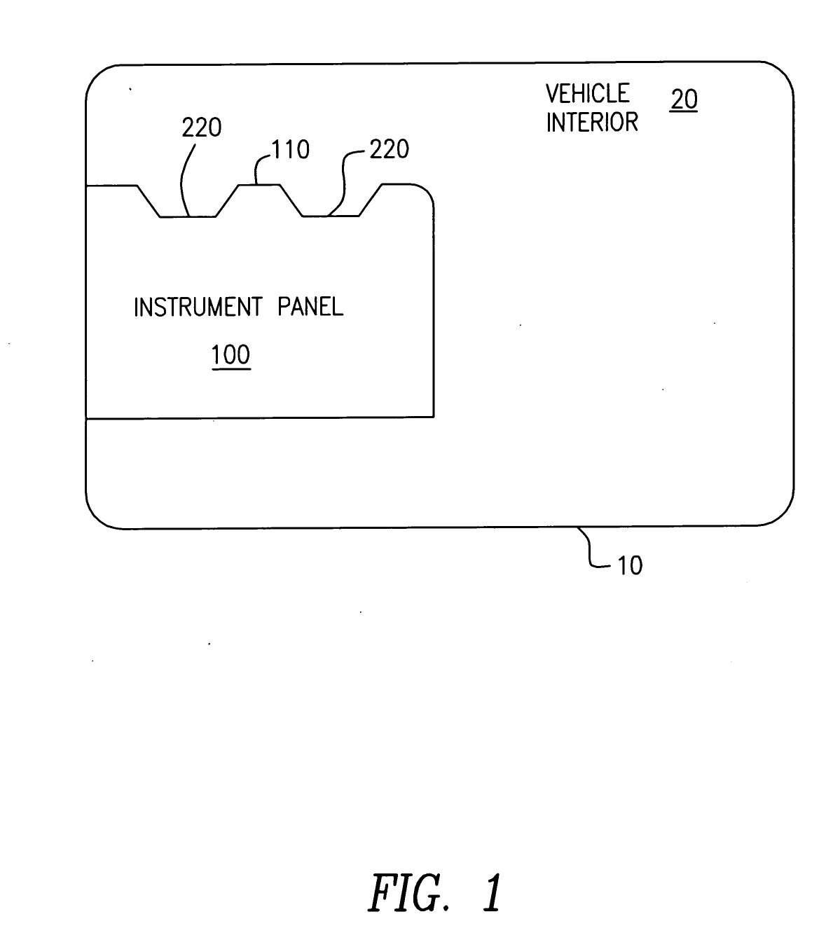

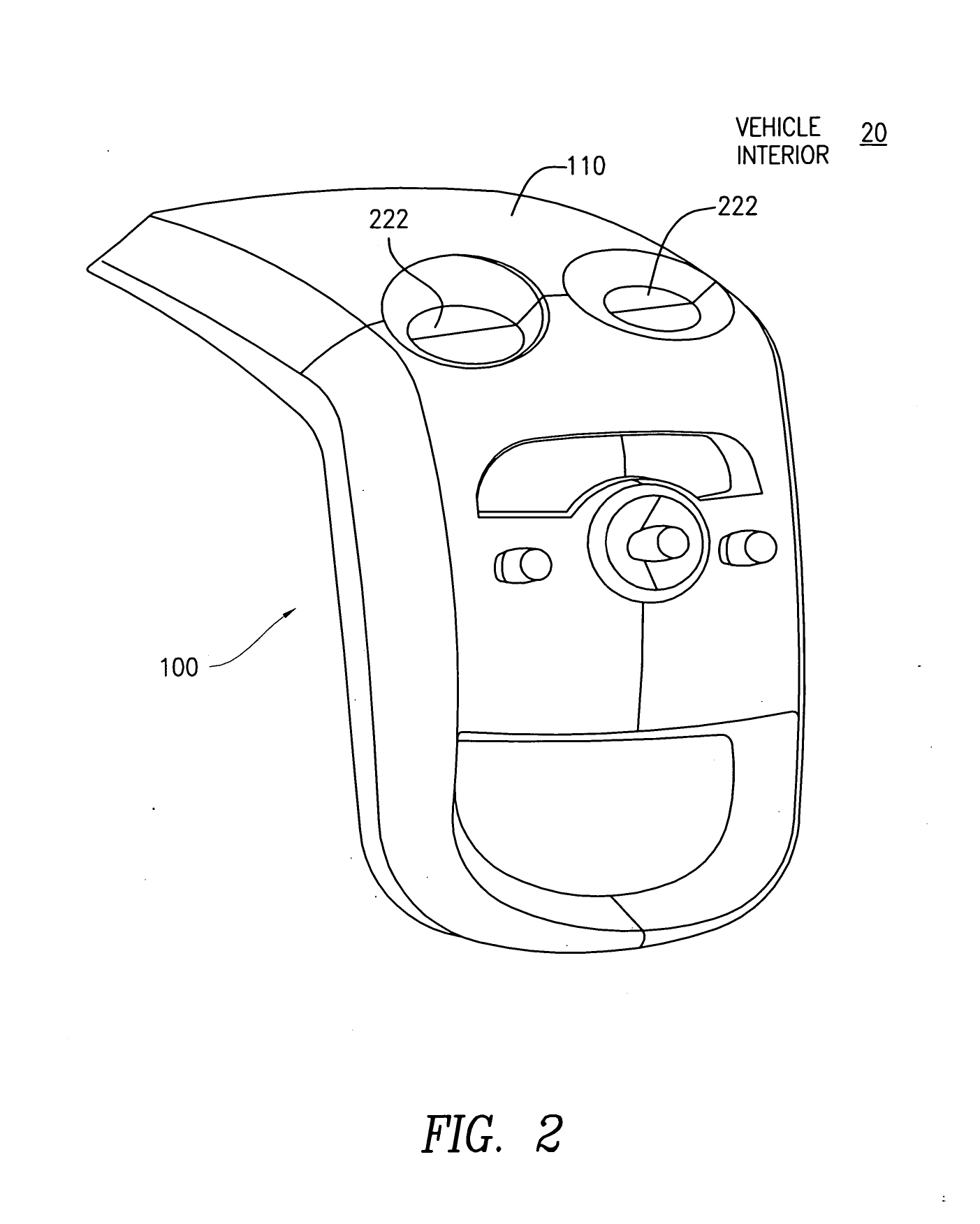

Reference is made to FIGS. 1-2 in the following. FIG. 1 is an elevational view of an instrument panel 100 including a plurality of air vents (air vent assemblies) 200 located adjacent to the interior 20 of a vehicle 10 in accordance with one or more embodiments of the present invention, and FIG. 2 is a perspective view of the instrument panel 100 of FIG. 1.

Instrument panel 100 may include two air vent assemblies 200 as shown in FIGS. 1-2, and surface 110. However, in alternative embodiments, fewer or more than two air vent assemblies 200 may be included in instrument panel 100. In the embodiment of FIGS. 1-2, air vent assemblies 200 are disposed along a horizontal portion of instrument panel 100, and air vent assemblies 200 face generally vertically upward within interior space 20 of vehicle 10. However, in alternative embodiments, air vent assemblies 200 may be oriented in any direction within vehicle interior 20.

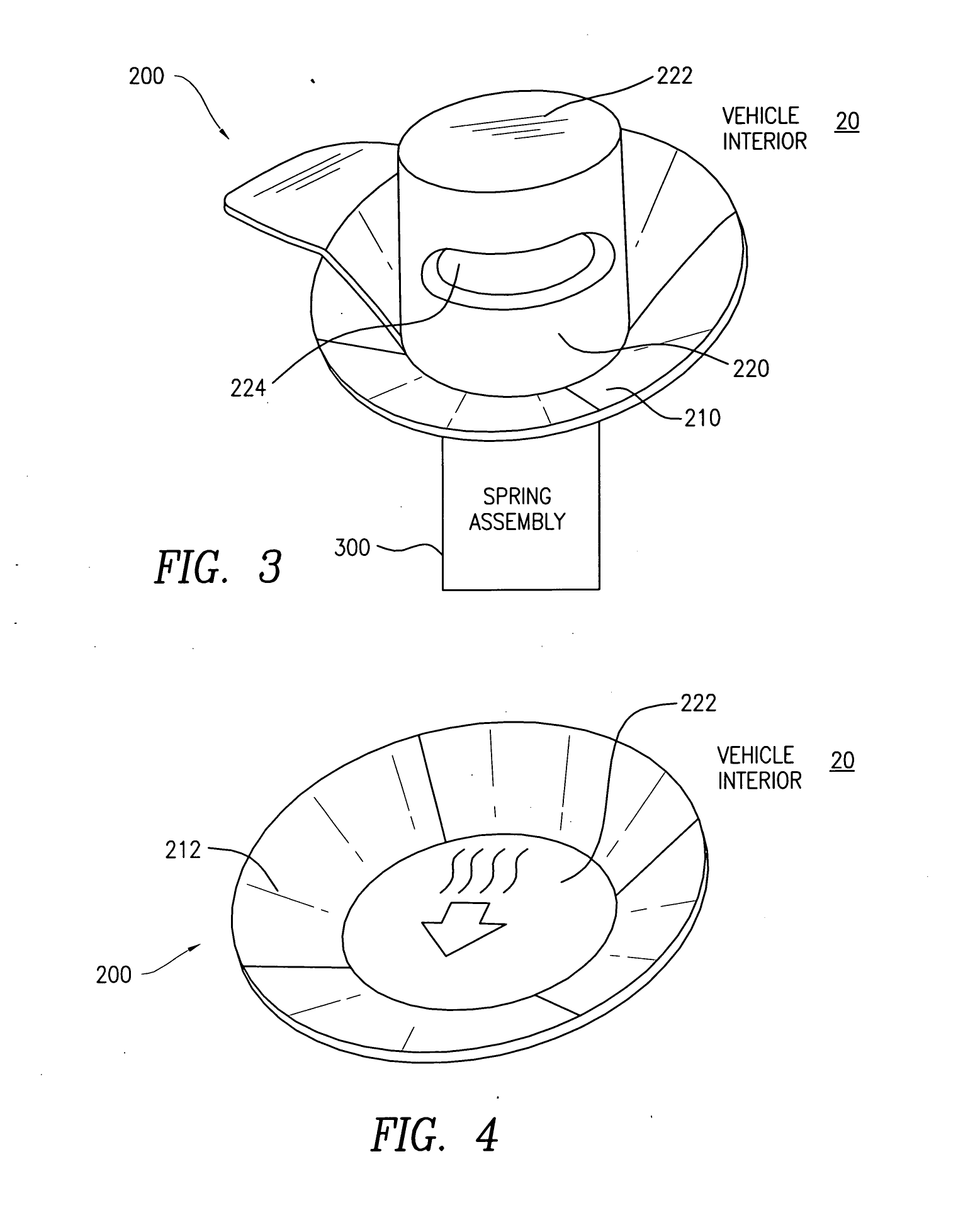

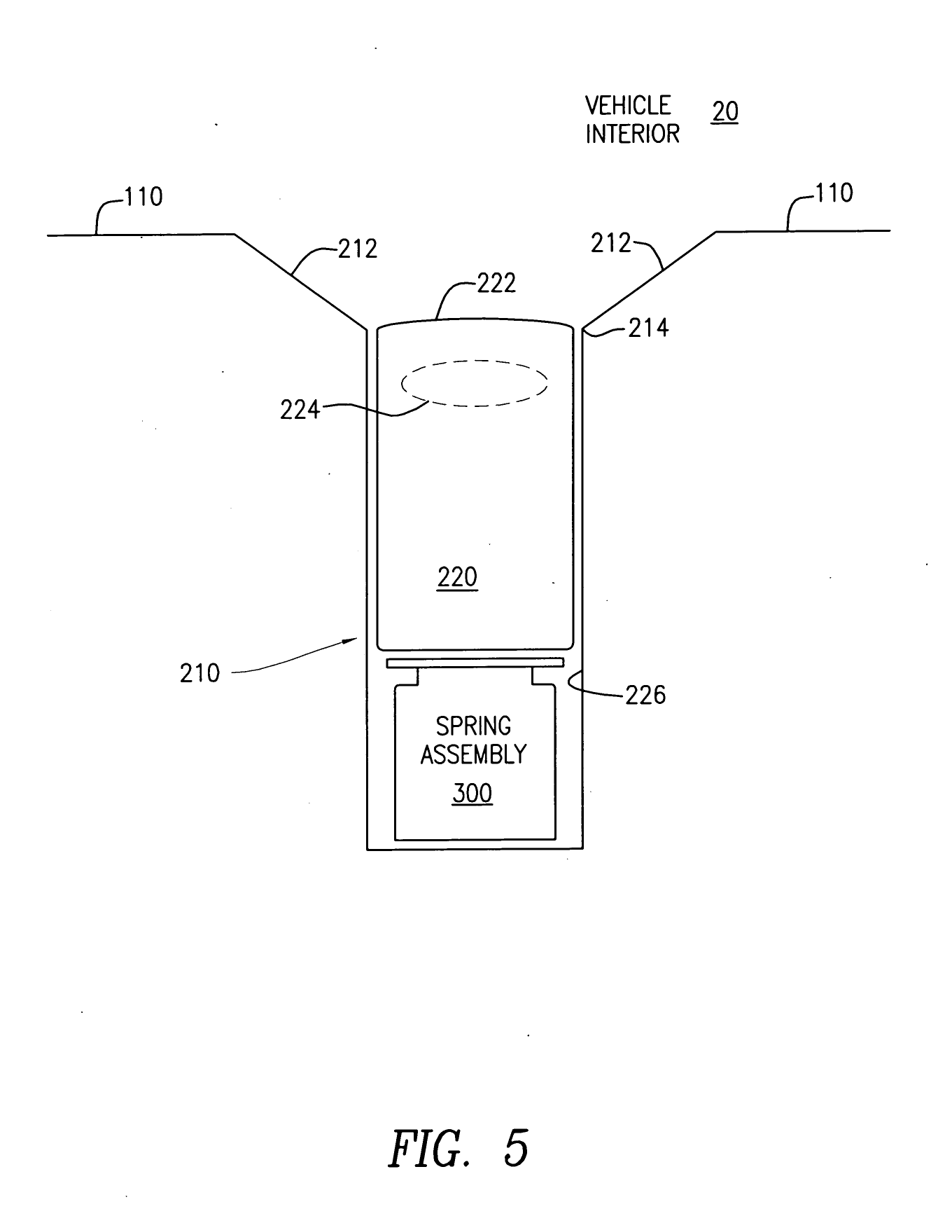

Air vent assembly 200 will now be described in greater detail with reference to FIGS. 3-5. FIG. 3 is a perspective view of air vent assembly 200 in an open position, in accordance with one or more embodiments of the present invention. FIG. 4 is a perspective view of air vent assembly 200 in a closed condition, in accordance with one or more embodiments of the present invention. And, FIG. 5 is a partially elevational and partially sectional view of a portion of air vent assembly 200.

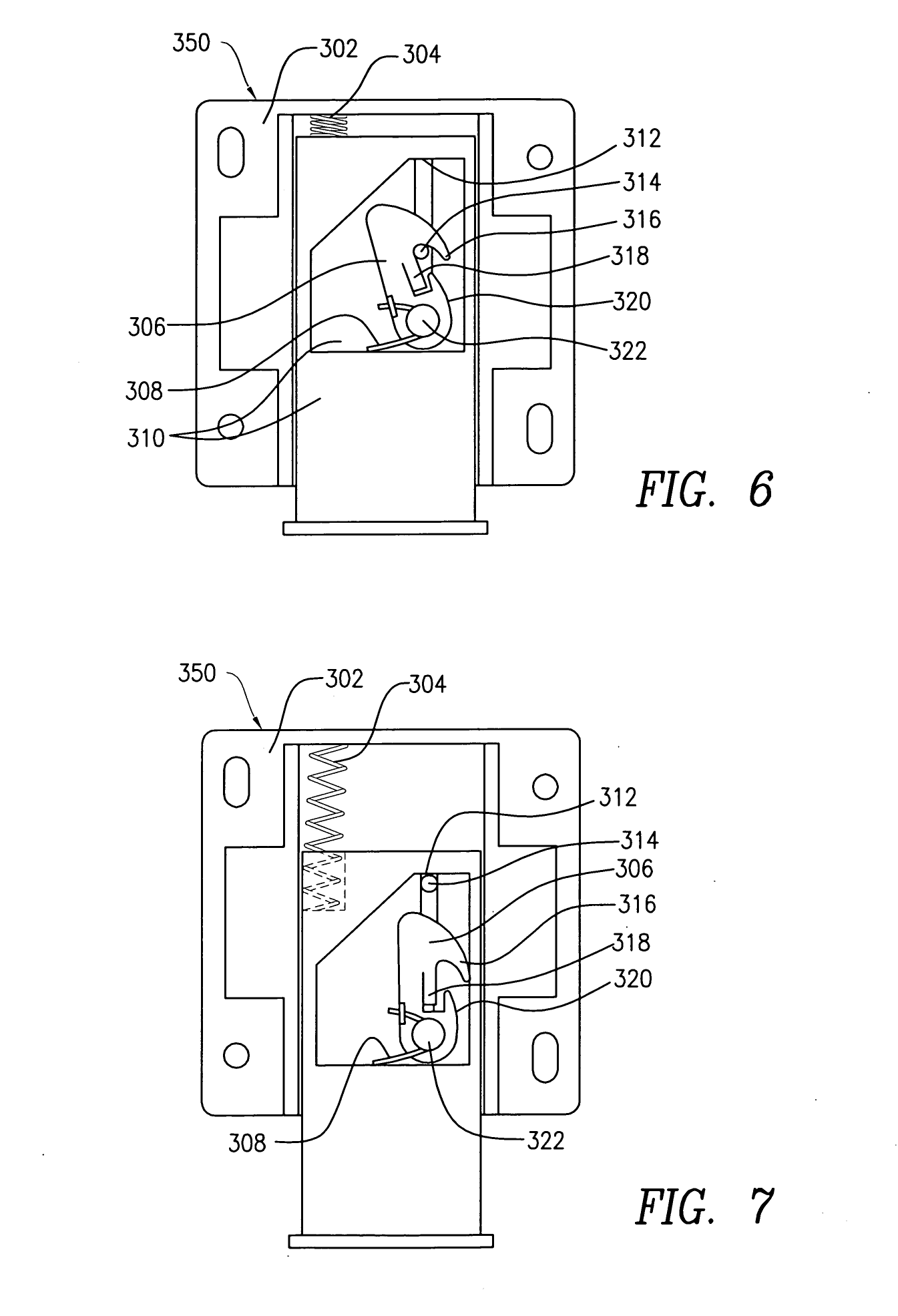

In a preferred embodiment, air vent assembly 200 may include sleeve 210 (FIG. 5), recessed flange 212 (which two parts may meet at junction 214), tube 220, and spring assembly 300, which may be a push-push latch mechanism, which mechanism is discussed in greater detail in conjunction with FIGS. 6-7. Tube 220 may include end cap 222 and air vent 224.

Herein, the term “extending,” as applied to tube 220, generally corresponds to moving tube 220 toward vehicle interior 20, and the term “retracting,” as applied to tube 220, generally corresponds to moving tube 200 away from vehicle interior 20.

Preferably, spring assembly 300 imposes a bias force against tube 220 tending to urge tube 220 toward vehicle interior 20. This bias force direction is preferably present whether air vent assembly 200 is open or closed.

In the open position depicted in FIG. 3, spring assembly 300 is preferably in an extended state, thereby extending tube 220 a desired distance out of sleeve 210 toward vehicle interior 20. In the closed position, spring assembly 300 is preferably latched in a retracted position in which tube 220 is retracted away from vehicle interior 20 and is preferably lodged at least substantially within sleeve 210.

When air vent assembly 200 is open, tube 220 may be extended toward vehicle interior 20 such that air outlet 224 is extended beyond junction 214 (FIG. 5) of sleeve 210 and recessed flange 212, thereby preferably removing any obstruction between air outlet 224 and vehicle interior 20 and thereby enabling air flow through air outlet 224 to and/or from vehicle interior 20. However, other air flow controls may be implemented to determine whether air flow through air outlet 224 actually occurs, the flow rate of such flow, the thermal conditions of same, among other ventilation control factors.

When air vent assembly 200 is open as shown in FIG. 3, tube 220 is preferably freely rotatable about its longitudinal axis to any angular position about this axis. The rotation of tube 220 may thus be employed to adjust the direction of air flow through air outlet 224 through a wide range of angular adjustment. In one or more embodiments, tube 220, and by extension air outlet 224, may be placed in any angular position throughout its 360-degree range of rotation. In one or more alternative embodiments, the rotation of tube 220 may be restricted to a range of rotation less than 360 degrees, such as 180 degrees, 90 degrees, or other selected angular range.

In one or more embodiments, when air vent assembly 200 is closed as shown in FIGS. 4-5, tube 220 may be retracted within sleeve 210 sufficiently far so that air flow through air outlet 224 is obstructed by sleeve interior surface 226 (FIG. 5). Moreover, when air vent assembly is closed, end cap 222 of tube 220 is preferably recessed within instrument panel 100. In this closed position, the outer (vehicle-interior) end of end cap 222 may be located near the junction 214 of recessed flange 212 and sleeve 210. In one or more embodiments, end cap 222 may be retracted within sleeve 210 slightly beyond junction 214 or extended out of sleeve 210 slightly beyond junction 214, or be positioned anywhere between these two positions.

In one or more embodiments, when starting with air vent assembly 200 in a closed position, air vent assembly 200 may be opened by pressing on and then releasing end cap 222 of tube 220, either manually or by other means, and allowing tube 220 to extend to its open position, thereby exposing air outlet 224 to vehicle interior 20. Similarly, when starting with air vent assembly 200 in the open position, air vent assembly 200 may be closed by pressing on end cap 222 of tube. 220, either manually or by other means, and pushing end cap 222 through its range of motion within sleeve 210 to a point slightly beyond its “closed” latching point and then releasing end cap 222 to allow spring assembly 300 to latch tube 220 into its closed position.

Tube 220 may move substantially linearly within sleeve 210 in a direction substantially perpendicular to the plane of instrument panel surface 110. However, in other embodiments, linear motion in other directions may be implemented. Moreover, the motion of tube 220 within sleeve 210 may include motion in one or more rotational dimensions either in addition to or in place of the above-described linear movement directions.

In one or more embodiments, the deployment of recessed flange 212 and the linear motion of tube 220 within sleeve 210 preferably combine to enable the desirable feature of enabling retracting end cap 222 of tube 220 beyond the level of instrument panel surface 110, thereby recessing end cap 222 within instrument panel 100. Where, as in FIGS. 1-5, end cap 222 of tube 220 is oriented vertically and faces upward, the deployment of recessed flange 212 and of linear motion of tube 220 enable retraction of end cap 222 “below” instrument panel surface 110.

In one or more embodiments, tube 220 and sleeve 210 have at least substantially circular cross-sectional geometries. However, the present invention is not limited to this configuration, and a variety of other cross-sectional geometries may be employed such as, but not limited to square, rectangular, oval and so forth.

FIG. 6 is a partially elevational and partially sectional view of a push-push latch mechanism (latch) 350 adaptable for use as a spring assembly with one or more embodiments of air vent assembly 200 disclosed herein. FIG. 6 depicts latch 350 in the retracted position. FIG. 7 is a partially elevational view and partially sectional view of the push-push latch mechanism 350 of FIG. 6 in an extended position.

In one embodiment, push-push latch mechanism 350 may include casing 302 and slider 310. Casing 302 may include spring 304 and pin 314. Slider 310 may include swing plate 306, torsional spring 308, and stopper 312. Swing plate 306 may include latch portion 316, sloped portion 318, and locking means 320. Swing plate 306 may be mobile along a small distance in the linear direction parallel to the axis of the shaft 322 about which it rotates. In the embodiment of FIGS. 6-7, torsional spring 308 is preferably configured to impart a clockwise-directed torsional force to swing plate 306.

According to one or more embodiments, push-push latch mechanism 350 may be latched in its compressed (retracted) position (FIG. 6) employing the steps described below.

In one or more embodiments, as slider 310 is pushed (usually manually) into casing 302, the edge of the swing plate 306 makes contact with pin 10 such that swing plate 306 swings counter-clockwise against the force of torsional spring 308. As the latch portion 316 of swing plate 306 passes pin 314, that part of swing plate 316 which is opposed to latch portion 316 may strike pin 314, thereby operating to oppose further progress of slider 310 into casing 302. At this point, the pushing force (which is directed upward in the view of FIG. 6) on slider 310 may be discontinued, and slider 310 may be allowed to move outward slightly from casing 302 through the operation of spring 304.

At the same time, swing plate 306 may be caused, by torsional spring 308, to rotate clockwise until latch portion 316 catches pin 314 to lock slider 310 in place, thereby latching push-push latch mechanism 350 in its retracted position. Where tube 220 (FIG. 5) is coupled to slider 310, the retracted position of push-push latch mechanism 350 corresponds to air vent assembly 200 being in the closed condition, as shown in FIGS. 4-5.

According to one or more embodiments, push-push latch mechanism 350 may be placed in its extended position employing the steps described below.

In one or more embodiments, if slider 310 is pushed while latched in the retracted position, swing plate 306, together with slider 310, may move a short distance toward the upper end (in the view of FIGS. 6-7) of casing 302 until the portion of swing plate 306 that is opposed to the latch portion 11 strikes the pin 10 and stops slider 310.

The movement of swing plate 306 toward the upper end of casing 302 preferably moves pin 314 closer to the raised end of sloped portion 318. Preferably, this action causes the raised end of the slope portion 318 to be positioned over pin 314. When the front end of the sloped portion 318 moves over pin 314, and the compressive (push) force urging slider 310 in the inward direction is removed, slider 310 is urged in the outward direction (downward in the view of FIGS. 6-7) by spring 304.

Swing plate 306, which it will be recalled is moveable in the direction parallel to the axis of shaft 322, guided by the sloped portion 318, gets displaced away from the base of pin 314 (i.e. toward the viewer of FIG. 6) as slider 310 moves out of casing 302. Ultimately, this motion away from the base of pin 314 causes swing plate 306 to move past the end (the end closest to the viewer of FIG. 6) of pin 314, thereby freeing swing plate 306 from pin 314 and enabling slider 310 to continue to move out of casing 302. Slider 310 preferably continues to move out of casing 302 until pin 314 encounters stopper 312, thereby halting the outward motion of slider 310 and securing push-push latch mechanism 350 in the extended position.

One embodiment of a push-push latch mechanism 350 that is adaptable for use as spring assembly 300 in conjunction with air vent assembly 200 described above. However, it will be recognized by those of ordinary skill in the art that air vent assembly 200 is not limited to being used with the latch mechanism described above. Any latch mechanism that is effective to latch in a retracted position upon being pushed and released a first time and to move to an extended position upon being pushed and released a second time may be adapted for use with one or more of the air vent embodiments described herein.

In one or more other alternative embodiments, the opening and/or closing of air vent assemblies 200 may be effected using means other than conventional metal springs, such as with compressed air, pressurized fluid, or other mechanism. Moreover, in one or more embodiments, electric motors and/or other automated means may be substituted for the manually operated systems discussed herein for opening and/or closing air vent assembly 200.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An air vent for a vehicle, comprising:
a sleeve coupled to a recessed flange which terminates at a surface of an instrument panel;
a tube disposed within said sleeve, being operable to move substantially linearly within said sleeve, and including an air outlet; and
a spring assembly operable to bias said tube toward an interior of said vehicle.

2. The air vent of claim 1 wherein when said air vent is closed, an end cap of said tube is retracted further from an interior of said vehicle than said instrument panel surface and said air outlet is retracted within said sleeve, thereby blocking air flow through said air outlet.

3. The air vent of claim 1 wherein when said air vent is open, said tube is located within said sleeve such that said air outlet is extended beyond a junction of said sleeve and said recessed flange, thereby enabling air flow through said air outlet.

4. The air vent of claim 1 wherein said tube is rotatable within said sleeve.

5. The air vent of claim 1 wherein said tube is rotatable to any angular position about a longitudinal axis thereof.

6. The air vent of claim 1 wherein said air vent is opened by pushing on an end cap of said tube.

7. The air vent of claim 1 wherein said air vent is closed by pushing on an end cap of said tube.

8. The air vent of claim 1 wherein said spring assembly comprises at least one torsional spring.

9. The air vent of claim 1 wherein said spring assembly comprises at least one linear spring.

10. The air vent of claim 1 wherein said spring assembly is a push-push latch mechanism.

11. A method, comprising:
providing a sleeve coupled to a recessed flange which terminates at a surface of an instrument panel facing an interior of a vehicle;
disposing a tube within said sleeve, said tube including an air outlet and an end cap at a vehicle-interior end of said tube, said sleeve, said flange, and said tube providing at least a portion of an air vent assembly;
providing substantially linear motion of said sleeve within said tube; and
spring-biasing said tube toward said vehicle interior.

12. The method of claim 11 further comprising:
retracting said end cap of said tube within said instrument panel to close said air vent assembly.

13. The method of claim 11 further comprising:
extending said tube toward said vehicle interior such that said air outlet is clear of said sleeve, thereby enabling air flow through said air outlet, thereby opening said air vent assembly.

14. The method of claim 13 wherein said opening said air vent assembly is effected by pushing and releasing said end cap.

15. The method of claim 14 wherein said pushing and releasing is performed manually.

16. The method of claim 11 further comprising:
retracting said tube away from said vehicle interior such that said air outlet is sealed by an interior surface of said sleeve, thereby disabling air flow through said air outlet, thereby closing said air vent assembly.

17. The method of claim 11 wherein said closing said air vent assembly is effected by pushing and releasing said end cap.
